(19) United States
(12) Patent Application Publication
(10) Pub. No.: US 2011/0221690 A1
(43) Pub. Date: Sep. 15, 2011

(54) INPUT DEVICE AND POINTING DEVICE

(75) Inventors: Kazuaki Miyoshi, Kusatsu-city (JP); Masahiro Kinoshita, Kyoto-city (JP)

(73) Assignee: OMRON CORPORATION, Kyoto-shi (JP)

(21) Appl. No.: 13/029,737

(22) Filed: Feb. 17, 2011

(30) Foreign Application Priority Data
Mar. 12, 2010 (JP) 2010-055955

(51) Int. Cl. G06F 3/041

(52) U.S. Cl. 345/173; 178/18.03

(57) ABSTRACT

An input device has an operation member, that is configured to be brushed by a finger of a user, and a detection unit for detecting a component of a force acting in a predetermined input direction with respect to the operation member when the user brushes the operation member. The input direction is two directions orthogonal to each other.

### BACKGROUND OF THE INVENTION

1. TECHNICAL FIELD

The present invention relates to an input device and a pointing device.

2. RELATED ART

Proposal has been made in U.S. Pat. No. 5,521,596, U.S. Pat. No. 5,798,754, Japanese Unexamined Patent Publication No. 7-117876, Japanese Patent Publication No. 4108401, and Japanese Patent Publication No. 4147839 to provide a stick or keys for the user to be displace in an arbitrary two-dimensional direction as an input device (pointing device) for moving a cursor and the like displayed in a portable device on a screen. In such input device, it is difficult for the user to intuitively grasp the movement amount (operation amount) of the cursor since the movement amount of the cursor is calculated based on the displacement amount of the stick or the key and the displacing time.

Thus, most notebook personal computer and the like adopt a pointing device such as a touch pad for detecting the coordinate of the position the user is touching. In the pointing device using the touch pad, the user can intuitively grasp the operation amount since the cursor moves according to the movement amount of the finger of the user.

However, it is difficult to adopt the touch pad in a small device such as a portable telephone since it occupies a relatively large installation area.

A portable telephone adopting a touch panel in which a touch sensor is arranged on a display device is released to enable the intuitive operation. In the touch panel, however, the accurate cursor position may not be known since the screen is covered by finger, and thus it is not suited for fine position specification. Many users keep distance from the touch panel as sebum attaches to the screen when the touch panel is operated.

### SUMMARY

An input device according to one or more embodiments of the present invention includes; an operation member, which a user brushes with a finger; and a detection unit for detecting a component of a force acting in a predetermined input direction with respect to the operation member when the user brushes the operation member.

According to such a configuration, the movement direction of the finger can be detected by detecting the small force acting on the operation member when moving the finger so as to brush the operation member. Since the finger is assumed to move while force is continuously acting on the operation member, the movement amount of the finger can be presumed based on the force acting on the operation member. The operation amount corresponding to the movement of the finger thus can be input. Furthermore, the operation member may be small since the acting force is simply detected and the distance does not need to be detected.

In the input device according to one or more embodiments of the present invention, the operation member may be displaced according to the component of the force acting in the input direction, a movable range is being regulated so that the displacement is a maximum when the force acting in the input direction is smaller than or equal to 1 N, and an inclination with respect to the input direction of the surface of an operable portion is being smaller than or equal to 45°; and the detection unit detects the component of the force acting in the input direction by a displacement amount of the operation member.

According to such a configuration, the operation member demonstrates a maximum displacement with a very small force of about a maximum of 1 N that acts when brushing the operation member as if tracing with the finger, and hence the frictional force and the detection range are corresponded and the magnitude of the frictional force can be detected at satisfactory sensitivity. Since the operation member is positioned at the movable end by the frictional force and such position does not change when the operation member is being brushed with the finger, it provides a definite feeling for the user to recognize the brushing of the operation member with the finger. Furthermore, since the inclination of the operation member is smaller than or equal to 45°, the finger slides the surface of the operation member and can smoothly brush the same. According to such effects, the correlation between the distance the user recognizes by sliding the finger on the operation member and the actual brushing amount becomes high, and thus the operation amount close to the feeling of the user can be input and the operation target such as the cursor on the screen can be moved as intended by the user.

In the input device according to one or more embodiments of the present invention, a maximum displacement of the operation member is smaller than or equal to 1 mm.

According to such a configuration, the movement of the operation member is not felt by the user since the displacement amount of the operation member is small, and furthermore, the operation amount closer to the feeling of the user can be input since the movement amount of the finger and the brushing distance are substantially equal.

In the input device according to one or more embodiments of the present invention, the operation member does not have a pump exceeding 0.2 mm at the operable portion.

According to such a configuration, the finger can be smoothly slid since the finger does not get caught.

In the input device according to one or more embodiments of the present invention, the operation member has a dimension in the input direction of the operable portion of smaller than or equal to 20 mm.

According to such a configuration, a linear operation feeing is obtained since the user is less likely to feel the movement of the operation member.

In the input device according to one or more embodiments of the present invention, the input direction is two directions orthogonal to each other.

According to such a configuration, the two-dimensional operation input can be made.

In the input device according to one or more embodiments of the present invention, the operation member may be pushed in a direction orthogonal to both input directions, and may further include a contact point mechanism for detecting the pushing of the operation member.

According to such a configuration, the input of the movement amount due to brushing of the operation member and the switch input due to pushing of the operation member can be made.

The pointing device according to one or more embodiments of the present invention includes one of the input devices and a display device capable of displaying a position, where the display position is moved by a distance corresponding to the force acting on the operation member detected by the detection unit.

According to such a configuration, a pointing device with satisfactory operation feeling can be provided to a small device since positioning can be made on the display device using the small input device.

In the pointing device according to one or more embodiments of the present invention, if a duration of a state the frictional force detected by the detection unit is greater than or equal to a predetermined threshold value is greater than or equal to a predetermined time threshold value, the display position of the display device may be moved according to the frictional force detected by the detection unit and the duration.

According to such a configuration, the display position does not move when the user unintentionally touches the operation member, and the display position can be moved according to the intended operation amount of the user.

In the pointing device according to one or more embodiments of the present invention, if the duration is smaller than the time threshold value, the direction of the frictional force acting on the operation member may be distinguished based on the frictional force detected by the detection unit, and the display position of the display device may be displaced according to the direction of the frictional force acting on the operation member.

According to such a configuration, the user operates the operation member as if flipping, so that the operation of inputting only the direction of moving the display position for every row can be carried out.

The electronic device according to one or more embodiments of the present invention includes one of the pointing devices.

According to such a configuration, a small electronic device having satisfactory operability can be provided.

### BRIEF DESCRIPTION OF THE DRAWINGS

FIG. 1 is a plan view of a portable information terminal according to a first embodiment of the present invention;

FIG. 2 is a partial cross-sectional view of the portable information terminal of FIG. 1;

FIG. 3 is a flow sheet of an operation amount calculation control of the portable information terminal of FIG. 1;

FIG. 4 is a vector diagram of a pushing force that acts on the operation member of FIG. 1;

FIG. 5 is a vector diagram of a reaction force of the operation member of FIG. 1;

FIG. 6 is a view showing a maximum value of the reaction force with respect to an inclination angle calculated from the standpoint of the vertical component of the reaction force acting on the finger from FIGS. 4 and 5;

FIG. 7 is a view showing a maximum value of the reaction force with respect to an inclination angle calculated from the standpoint of the horizontal component of the reaction force acting on the finger from FIGS. 4 and 5;

FIG. 8 is a plan view of a portable information terminal according to a second embodiment of the present invention;

FIG. 9 is a partial exploded perspective view of the portable information terminal of FIG. 8; and

FIG. 10 is a partial cross-sectional view of the portable information terminal of FIG. 8.

### DETAILED DESCRIPTION

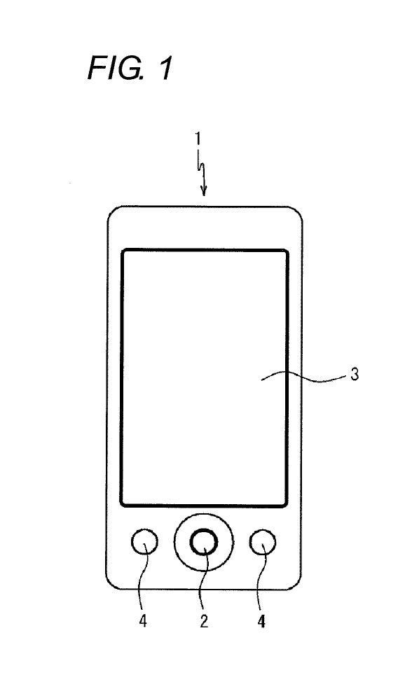

Hereinafter, embodiments of the present invention will be described with reference to the drawings. In embodiments of the invention, numerous specific details are set forth in order to provide a more thorough understanding of the invention. However, it will be apparent to one of ordinary skill in the art that the invention may be practiced without these specific details. In other instances, well-known features have not been described in detail to avoid obscuring the invention. FIG. 1 shows a portable information terminal (electronic device) 1 serving as a first embodiment of the present invention. The portable information terminal 1 includes an input device 2 according to one or more embodiments of the present invention, a display device 3 including a liquid crystal panel, and two push button switches 4. The display device 3 displays varied information, a cursor that can be freely moved when the user operates the input device 2, and the like.

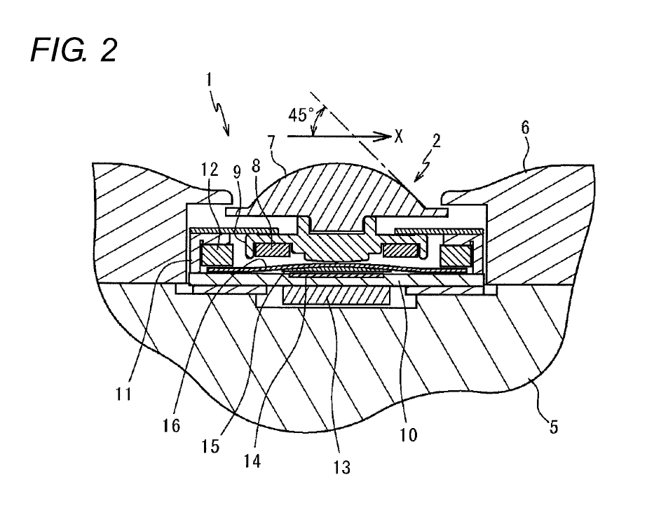

FIG. 2 shows a cross-section of the portable information terminal 1 for showing the structure of the input device 2. The input device 2 is arranged in a space between a main body 5 and a cover 6 of the portable information terminal 1. The input device 2 includes a movable member 9 for holding an operation member 7 exposed from an opening of the cover 6 and an annular movable magnet 8, and a fixed magnet 12 fixed to a substrate 10 and a case 11.

The movable magnet 8 and the fixed magnet 12 have magnetic forces that repel each other, where the movable member 9 is biased so as to be positioned at the center (origin) of the fixed magnet 12 by such magnetic forces. When an external force is applied on the operation member 7, the movable member 9 can be moved on the inner side of the fixed magnet 12 in the two-dimensional input direction of the X-direction shown with an arrow and the Y-direction in the depth direction in the plane of drawing orthogonal to the X-direction against the magnetic force.

The movable range of the movable member 9 regulated by the fixed member 12 is a maximum of ±0.5 mm in the X and Y directions, respectively. The reaction force by the magnetic force when the movable member 9 is moved 0.5 mm, which is a maximum from the origin, is 0.35 N. That is, the component in the movement direction of the external force to be applied on the operation member 7 in order to move the movable member 9 to a maximum is 0.35 N.

The input device 2 has a Hall IC 13 mounted on the substrate 10. The hall IC 13 a detection unit incorporating four hall elements is for detecting the magnetic field generated by the movable magnet 8 and outputting positions in the XY directions of the movable magnet 8 as coordinate data. The hall IC 13 of the present embodiment can output the position of the movable magnet 8 as a coordinate (digital value) of (0, 0) to (255, 255). The coordinate of the origin by the magnetic force is (127, 127) in terms of the design. However, as described above, the movable range of the movable member 9 is narrow, and the change in coordinate actually output by the hall IC 13 is within the range of ±20 the origin.

Furthermore, the input device 2 has a contact point mechanism capable of being conducted for contact point output by pushing the operation member 7 towards the substrate 10. Specifically, the contact point mechanism includes a lower electrode 14 formed on the substrate 10, and a pekoe plate 16, which bulges out to a dome shape so as to cover the lower electrode 14, and which is formed with an upper electrode 15 at a position facing the lower electrode 14 at the inner surface of the dome.

The operation member 7 is a sphere exposed from the cover 6, and having a smooth surface shape at the portion where the user can touch, where the maximum inclination with respect to the XY plane is 45°. The diameter of the exposed portion of the operation member 7 is about 6 mm.

In the portable information terminal 1, the user inputs the displacement by brushing the operation member 7 of the input device 2 with a finger to move the display position of the cursor and the like on the display device 3 (pointing device). When the user brushes the operation member 7 with a finger, the operation member 7 is displaced in the XY direction in proportion to the component in the XY directions of the frictional force of the finger of the user. The portable information terminal 1 includes a micro-computer (calculation device) for calculating the displacement amount of the cursor corresponding to the movement amount (brushed amount) of the finger of the user on the operation member 7 based on the coordinate data of the position of the moveable member 9 detected by the hall IC 13.

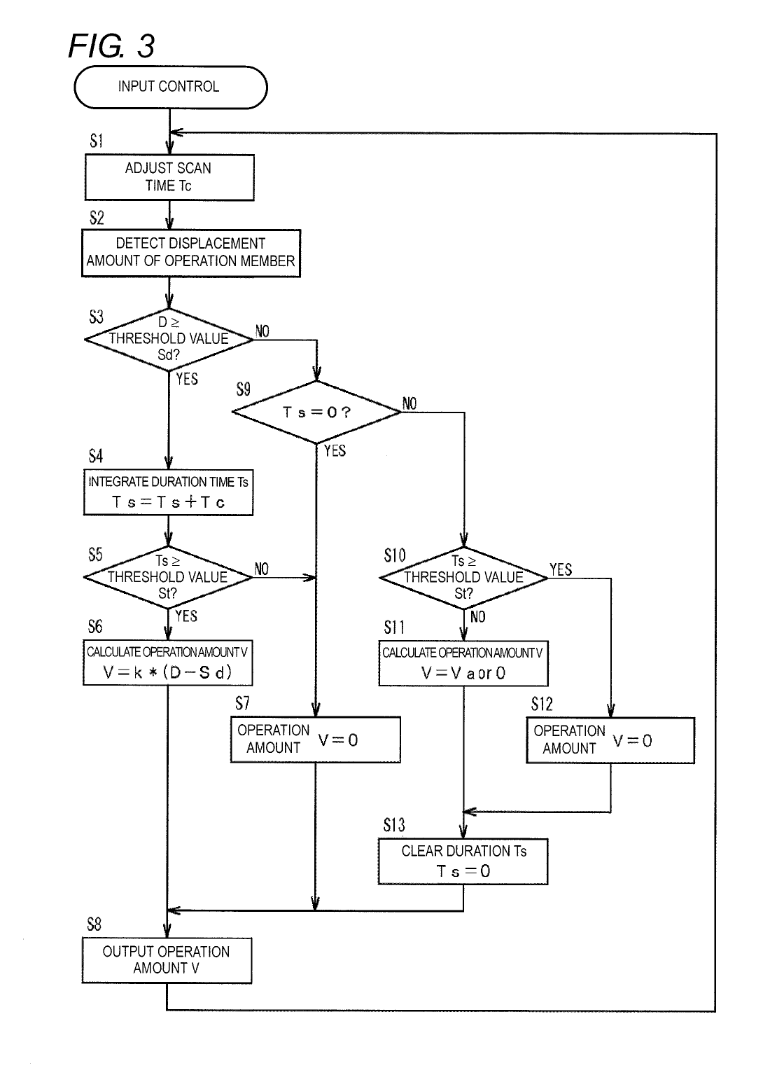

FIG. 3 shows a method of calculating the displacement amount of the cursor by the microcomputer of the portable information terminal 1. The illustrated flowchart is executed once every constant scan time Tc=20 msec by the time adjustment of step S1. In this control, the output of the hall IC 13 is checked, and the displacement D of the operation member 7 is detected for the X direction and the Y direction in step S2. Specifically, the calculation of subtracting the coordinate of the origin from the output coordinate of the hall IC is carried out.

Thereafter, in step S3, the displacement amount D is compared with a predetermined detection threshold value Sd or the coordinate value 5in the present embodiment, that is, 0.125 mm in the displacement of the operation member 7. The value of the detection threshold value Ds corresponds to 0.09 N for the component in the XY directions of the frictional force that acts on the operation member 7. If the displacement amount D is greater than or equal to the detection threshold value Sd, the scan time Tc is added to the parameter Ts indicating the duration of the state in which the displacement amount D is greater than or equal to the detection threshold value Sd in step S4.

In step S5, the duration Ts is compared with a predetermined time threshold value St or 0.2 sec in the present embodiment. If the duration Ts is greater than or equal to the time threshold value St, determination is made that the user is brushing the operation member 7, and the operation amount V or the distance for moving the cursor on the display device 3 is calculated for the X-direction and the Y-direction in step S6. Specifically, a value obtained by multiplying a predetermined coefficient k to a value in which the detection threshold value Sd is subtracted from the displacement amount D of the operation member is assumed as the operation amount V. The coefficient k is defined according to conditions such as the output scale of the hall IC, the shape of the operation member 7, the scan time Tc, the pixel pitch of the display device 3, and the like, and may be 1.

If the duration time Ts is smaller than the time threshold value St in step S5, determination is made that the user is not performing the operation of brushing the operation member 7, and the operation amount V is set to “0” in step S7. In step S8, the operation amount set in step S6 or step S7 is output to the display device to move the display position of the cursor on the coordinate of the display device 3.

After the output of the operation amount is performed in step S8, the process returns to step S1 to repeat the above control. In other words, in the present embodiment, if a state displaced by greater than or equal to 0.125 mm is continued for greater than or equal to 0.2 sec when the operation member 7 receives the frictional force of greater than or equal to 0.09 N, the cursor is thereafter moved for every scan time Tc in proportion to the amount exceeding 0.125 mm of the displacement amount D of the operation member 7. The frictional force of when brushing the operation member 7 with the finger is normally within the range of 0.5 to 1 N, but the displacement amount D of the operation member 7 becomes a maximum when the frictional force is 0.35 N. Thus, the displacement amount D mostly demonstrates a maximum value in the normal brushing operation, and hence the cursor moves at a substantially constant speed while the user brushes the operation member 7.

In the portable information terminal 1, the user can input only the direction by operating the operation member 7 as if flipping with fingers. For instance, when the operation member 7 is flipped in the direction corresponding to four cells at above, below, left, and right adjacent to the selected cell or eight adjacent cells at above, below, left, right, and diagonal, the operation of selecting one of the adjacent cells can be performed.

Specifically, if the displacement amount D is smaller than the detection threshold value Sd in step S3, whether or not the duration Ts is “0” is checked in step S9. If the displacement amount D is greater than or equal to the detection threshold value Sd in the previous scan, the duration Ts is at least greater than or equal to Tc, and thus whether or not an external force is applied to the operation member 7 until immediately before is checked in step S9. If determined that the operation member 7 is not operated immediately before, the operation amount V is set to “0” in step S7.

If the duration time Ts is not “0” in step S9, whether or not the duration time Ts is greater than or equal to the time threshold value St is checked in step S10. If the duration time Ts is smaller than the time threshold value St in step S10, the user flips the operation member 7 with the fingers to be determined that the displacement exceeding the detection threshold value Sd is given to the operation member 7 by a time less than 0.2 second.

In this case, in step S11, the displacement direction of the operation member 7 is distinguished as four azimuths or eight azimuths from the ration of the X component and the Y component of the displacement amount D, and the value Va defined in advance according to the distinguished direction is assumed as the operation amount V. In this case, the operation amount of the direction in which the displacement is not confirmed is set to “0”. The value of Va may be a value that differs depending on the distinguished direction or may be set to a different value according to the current cursor display device or the application being executed.

The duration Ts in step S10 is a value integrated in step S5 in the previous scan, and thus if such value is greater than or equal to the time threshold value St, this means that the operation amount V corresponding to the brush amount is set in step S6, the operation amount V is output in step S8, and the cursor of the display device 3 is moved in the scan immediately before. In this case, therefore, the operation amount V is set to “0” in step S12 so that the cursor is not redundantly moved.

After the operation amount V is set in step S11 or step S12, the duration Ts is returned to “0” in step S12. Thus, after the continuous detection of the displacement of the operation member 7 is completed, the operation amount is output in step S8, and then the process is returned to step S1 to start the next detection cycle.

Therefore, the input device 2 of the present embodiment detects the frictional force of when brushing the operation member 7. Thus, the shape of the portion the user of the operation member 7 operates, that is, the portion the user touches needs to be a slidable shape so that the finger of the user does not get caught.

The surface of the operation member 7 is thus desirably formed flat. In particular, if a bump is formed on the surface of the operation member 7 at a height of 0.15 mm if singular and at an interval greater than 0.2 mm if continued, a feeling the finger gets caught is felt and a smoothly sliding operation feeling may not be obtained. Thus, the surface of the portion of the operation member 7 operable with the finger is desirably formed to a shape without bumps as much as possible.

Moreover, If the operation member 7 has a large recess shape, the finger is placed in the recess so as to easily feel the displacement of the operation member 7 involved in the movement of the finger, and thus the operation member 7 according to one or more embodiments of the present invention has a projection shape to give a sense of brushing the operation member 7 to the user.

When a human brushes as if tracing the plane with the finger such as when operating the touch pad, it was found through experiments that the pushing force with respect to the surface is 0.5 to 1 N, and the acting friction force is 0.25 to 1 N.

Thus, the operation member 7 needs to be able to be displaced with a very small external force to enable the detection of the frictional force of a maximum of 1 N that occurs when brushed with the finger. In order for the user to brush the operation member 7 with the finger and obtain the feeling, the operation member 7 desirably does not move as much as possible, and hence the movable range of the operation member 7 according to one or more embodiments of the present invention is regulated such that the displacement amount thereof becomes a maximum at the maximum 1 N. That is, the operation member 7 mostly indicates a maximum displacement when the user brushes the operation member 7 with the finger.

The maximum displacement amount of the operation member 7 of the present embodiment is ±0.5 mm, but the user can feel as if brushing the completely fixed operation member 7 with the finger without feeling the movement of the operation member 7 if the displacement amount of the operation member 7 is smaller than or equal to ±1 mm. Furthermore, since the movement of the operation member 7 cancels out the movement of the finger of the user, it becomes a “play” with respect to the detection of the input device. The displacement amount of the operation member 7 is desirably small from this standpoint as well.

If the size of the operation member 7 is small to an extent it can be hidden under the finger, the displacement of the operation member 7 is also not visually recognized by the user. When the user simply moves the finger to brush the operation member 7 once, the movement distance of the fingertip is about 30 mm. The feeling of stroking the operation member 7 once can be obtained by having the size of the operation member 7 to the size of an extent it can be brushed from end to end in the XY direction by the movement of the fingertip, specifically, to smaller than or equal to 20 mm. The user can predict the movement amount of the cursor on the display device 3 by experimentally recognizing the operation amount of when stroking the operation member 7 once. Thus, the operation member 7 according to one or more embodiments of the present invention is formed to a projection shape so that the user can recognize the contact with the operation member 7 to reduce the size of the operation member 7.

Description has been made that the pushing force of when a human brushes the plane with the finger is 0.5 to 1 N, and the acting frictional force is 0.25 to 1 N. However, if the operation member 7 is formed to a projection shape as in the present embodiment, the user will touch the surface inclined with respect to the XY direction for the input of the displacement of the operation member 7. Thus, the acting force slightly differs from when the surface is a horizontal surface.

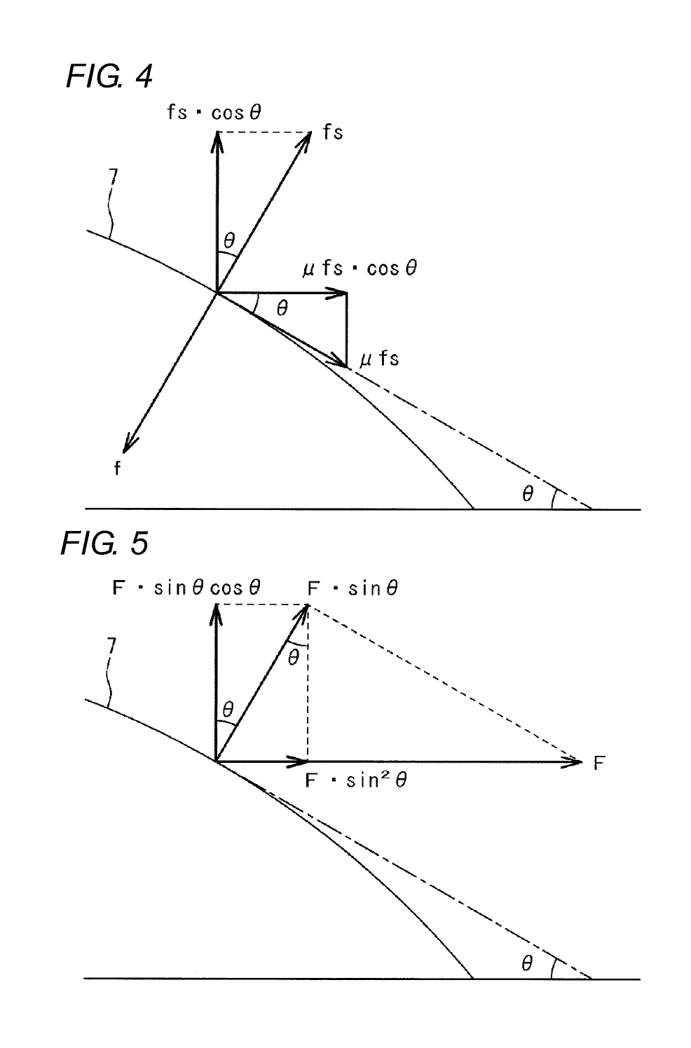

FIG. 4 shows the reaction force that acts on the finger of the user from the inclined surface in vectors. Assuming that the finger of the user is pushed with a constant pushing force f at a position inclined by an angle θ with respect to the X direction at the surface of the operation member 7, the operation member 7 pushes back the finger at the reaction force fs in the opposite direction with the magnitude equal to the pushing force f of the finger. In this case, the user recognizes the vertical component of the reaction force fs, that is, fs·cos θ as the reaction force in the vertical direction. A frictional force proportional to the reaction force fs acts between the finer and the operation member 7. The magnitude of the frictional force is μfs, where μ is a friction coefficient. The frictional force acts in the direction inclined by angle θ with respect to the X direction, and thus the X direction component of the frictional force is μfs·cos θ. The user recognizes the X-direction component of the frictional force as the horizontal component of the reaction force from the operation member 7.

On the other hand, a reaction force corresponding to the displacement acts on the operation member 7. FIG. 5 shows the reaction force of the operation member 7 as F in vectors. The reaction force F acts in the X direction. Therefore, the component in the normal direction of the operation member 7 of the reaction force F is F·sin θ. Such component in the normal direction is transmitted to the finger of the user. Therefore, the component force Fsin θcos θ in the vertical direction of the component F·sin θ of the normal direction of the reaction force F is the vertical component transmitted to the user, and the component force F·sin² θ in the horizontal direction of the component F·sin θ of the normal direction of the reaction force F is the horizontal component transmitted to the user.

As the component in the vertical direction and the component in the horizontal direction of the force transmitted to the user by the reaction force F become greater than the vertical component and the horizontal component of the reaction force of the pushing force of the finger, respectively, the user can obtain a feeling different from when brushing the operation member 7 as if stroking with the finger, and hence feels that the operation member 7 cannot be appropriately brushed. Thus, fs·cos θ≧F·sin θcos θ and μfs·cos θ≧F·sin² θ are to be realized.

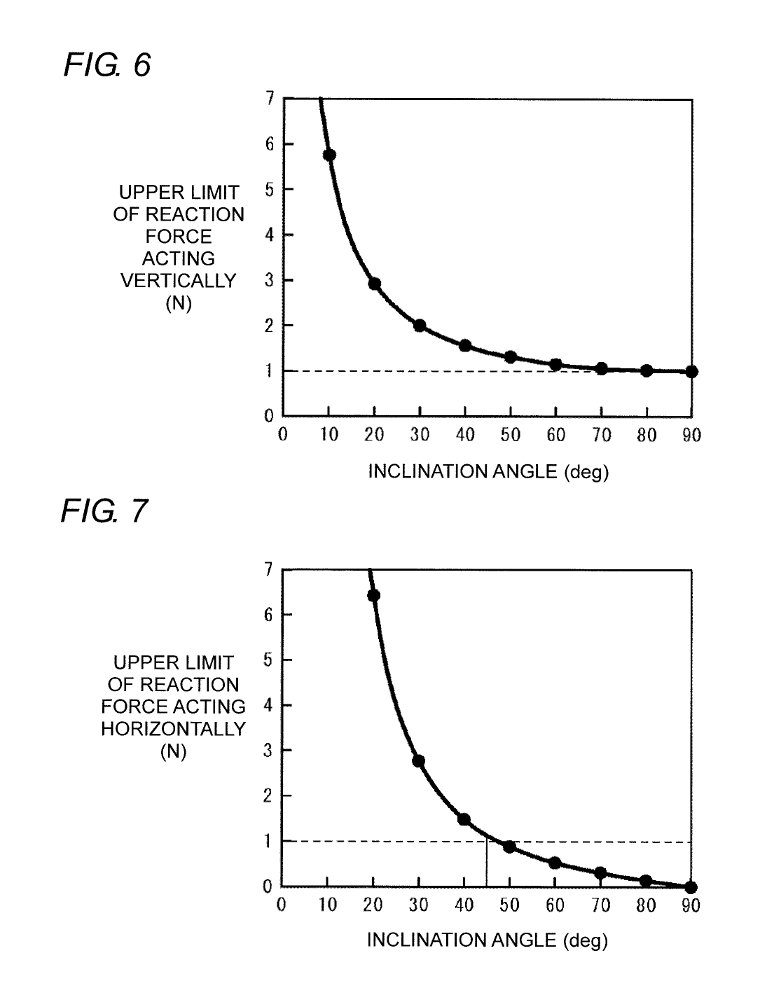

The upper limit value of the reaction force F of the operation member 7 is calculated for the vertical component and the horizontal component assuming that fs is 1 N or the maximum value of the pushing force and the friction coefficient μ is 0.8 or a value of the friction coefficient between a typical resin material and a finger. FIG. 6 shows the upper limit value of the reaction force F defined for the vertical component, and FIG. 7 shows the upper limit value of the reaction force F defined for the horizontal component. As shown in the figures, greater recovery force F can be obtained with smaller inclination angle of the operation member 7 in terms of both the vertical component and the horizontal component of the reaction force.

When the inclination angle is greater than or equal to 45°, the load in the horizontal direction becomes greater than the vertical direction and it becomes difficult for the finger to brush in the horizontal direction. That is, the inclination angle needs to be smaller than or equal to 45°. In this case, the restoring force F that satisfies the conditional equations of FIGS. 6 and 7 at smaller than or equal to 45° becomes smaller than or equal to 1 N.

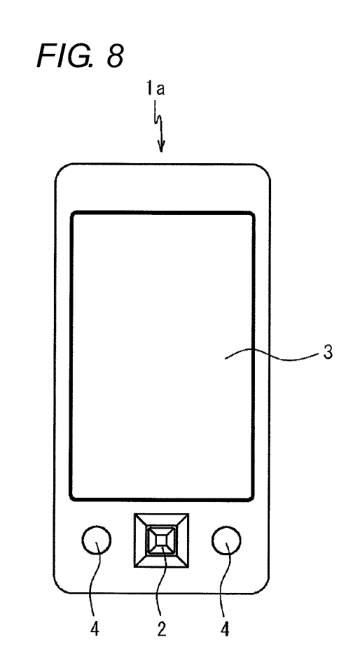

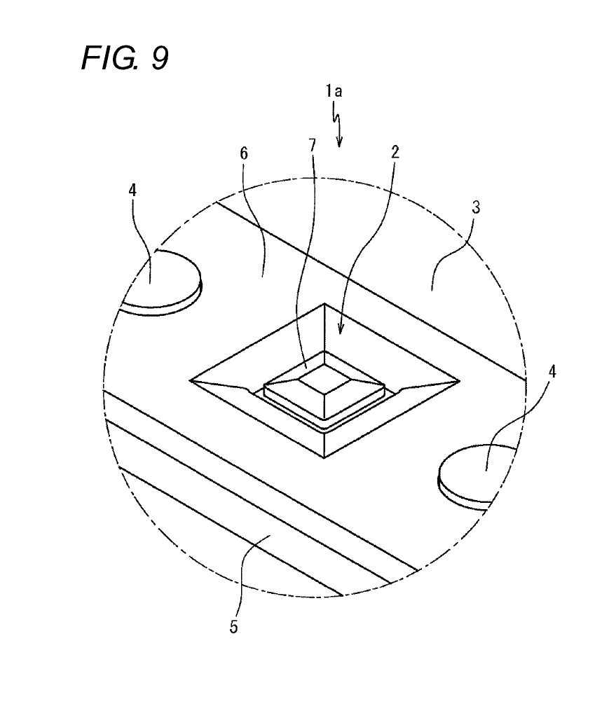

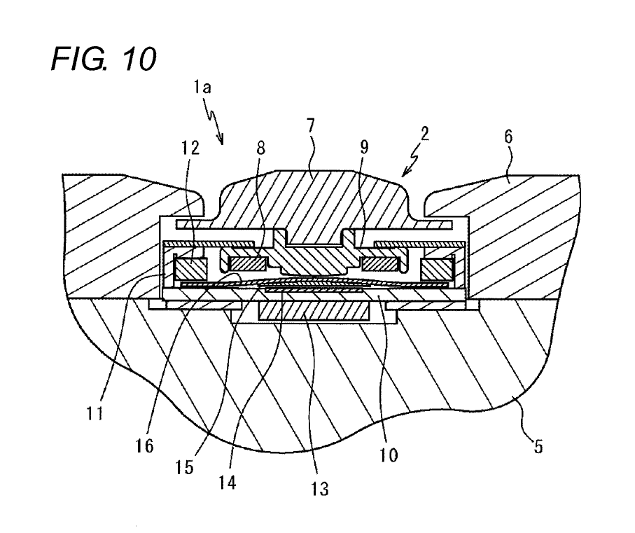

FIGS. 8 to 10 show a portable information terminal 1a according to a second embodiment of the present invention. In the present embodiment, the same reference numerals are denoted for the configuring elements same as the portable information terminal 1 of the first embodiment, and the redundant description will be omitted. The portable information terminal 1a of the present embodiment has the operation member 7 of the input device 2 formed to a square pyramid in which the inclination of the side surface is about 17° with respect to the XY plane.

The four side surfaces of the operation member 7 are inclined in the positive and negative directions in the XY directions, respectively by forming the operation member 7 to a square pyramid. Thus, the direction the displacement being input by the movement of the finger can be easily recognized even if the movement distance of the finger is short when the user brushes the operation member 7.

The input device 2 of the first embodiment and the second embodiment includes the hall IC 13 capable of outputting the coordinate corresponding to the displacement amount of the operation member 7. However, the operation member 7 mostly indicates a maximum displacement while the user is brushing the operation member 7. Therefore, the input device 2 may be configured to include a switch that outputs a contacting point when the displacement amount of the operation member 7 becomes greater than or equal to a certain amount in each direction of positive and negative in the X direction, and positive and negative in the Y direction other than the configuration of outputting a value that changes according to the displacement of the operation member 7. In such a case, whether the switch is turned ON is checked in step S3 of the flowchart of FIG. 3, and the operation amount V is set to a constant value defined in advance.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

1. An input device comprising:
an operation member, which is configured to be brushed by finger of a user; and
a detection unit for detecting a component of a force acting in a predetermined input direction with respect to the operation member when the user brushes the operation member.

2. The input device according to claim 1, wherein
the operation member is displaced according to the component of the force acting in the input direction, a movable range being regulated so that the displacement is a maximum when the force acting in the input direction is smaller than or equal to 1 N, and an inclination with respect to the input direction of the surface of an operable portion being smaller than or equal to 45°; and
the detection unit detects the component of the force acting in the input direction by a displacement amount of the operation member.

3. The input device according to claim 1, wherein a maximum displacement of the operation member is smaller than or equal to 1 mm.

4. The input device according to claim 1, wherein the operation member does not have a pump exceeding 0.2 mm at the operable portion.

5. The input device according to claim 1, wherein the operation member has a dimension in the input direction of the operable portion of smaller than or equal to 20 mm.

6. The input device according to claim 1, wherein the input direction is two directions orthogonal to each other.

7. The input device according to claim 6, wherein the operation member may be pushed in a direction orthogonal to both input directions, and further includes a contact point mechanism for detecting the pushing of the operation member.

8. A pointing device comprising:
the input device according to claim 1; and
a display device for displaying a position,
wherein a display position is moved by a distance corresponding to a frictional force detected by the detection unit for every predetermined time.

9. The pointing device according to claim 8, wherein if a duration of a state the frictional force detected by the detection unit is greater than or equal to a predetermined threshold value is greater than or equal to a predetermined time threshold value, the display position of the display device is moved according to the frictional force detected by the detection unit and the duration.

10. The pointing device according to claim 9, wherein if the duration is smaller than the time threshold value, the direction of the frictional force acting on the operation member is distinguished based on the frictional force detected by the detection unit, and the display position of the display device is displaced according to the direction of the frictional force acting on the operation member.

11. An electronic device comprising the pointing device according to claim 8.

12. The input device according to claim 2, wherein a maximum displacement of the operation member is smaller than or equal to 1 mm.

13. The input device according to claim 2, wherein the operation member does not have a pump exceeding 0.2 mm at the operable portion.

14. The input device according to claim 3, wherein the operation member does not have a pump exceeding 0.2 mm at the operable portion.

15. The input device according to claim 12, wherein the operation member does not have a pump exceeding 0.2 mm at the operable portion.

16. The input device according to claim 2, wherein the operation member has a dimension in the input direction of the operable portion of smaller than or equal to 20 mm.

17. The input device according to claim 3, wherein the operation member has a dimension in the input direction of the operable portion of smaller than or equal to 20 mm.

18. The input device according to claim 4, wherein the operation member has a dimension in the input direction of the operable portion of smaller than or equal to 20 mm.

19. An electronic device comprising:
a pointing device comprising:
an input device comprising:
an operation member, which is configured to be brushed by finger of a user; and
a detection unit for detecting a component of a force acting in a predetermined input direction with respect to the operation member when the user brushes the operation member,
wherein the operation member is displaced according to the component of the force acting in the input direction, a movable range being regulated so that the displacement is a maximum when the force acting in the input direction is smaller than or equal to 1 N, and an inclination with respect to the input direction of the surface of an operable portion being smaller than or equal to 45°,
wherein the detection unit detects the component of the force acting in the input direction by a displacement amount of the operation member,
wherein a maximum displacement of the operation member is smaller than or equal to 1 mm,
wherein the operation member does not have a pump exceeding 0.2 mm at the operable portion,
wherein the operation member has a dimension in the input direction of the operable portion of smaller than or equal to 20 mm,
wherein the input direction is two directions orthogonal to each other, and
wherein the operation member may be pushed in a direction orthogonal to both input directions, and further includes a contact point mechanism for detecting the pushing of the operation member; and
a display device for displaying a position,
wherein a display position is moved by a distance corresponding to a frictional force detected by the detection unit for every predetermined time,
wherein if a duration of a state the frictional force detected by the detection unit is greater than or equal to a predetermined threshold value is greater than or equal to a predetermined time threshold value, the display position of the display device is moved according to the frictional force detected by the detection unit and the duration, and
wherein if the duration is smaller than the time threshold value, the direction of the frictional force acting on the operation member is distinguished based on the frictional force detected by the detection unit, and the display position of the display device is displaced according to the direction of the frictional force acting on the operation member.
